(19) United States
(12) Patent Application Publication
(10) Pub. No.: US 2023/0385830 A1
(43) Pub. Date: Nov. 30, 2023

(54) Multiple billing computer system identification and payment processing

(71) Applicant: Boku, Inc., San Francisco, CA (US)

(72) Inventors: Chris Wachowicz, London (GB); David McLellan, London (GB); Jonathan Prideaux, Guildford (GB)

(73) Assignee: Boku, Inc., San Francisco, CA (US)

(21) Appl. No.: 18/313,217

(22) Filed: May 5, 2023

Related U.S. Application Data
(60) Provisional application No. 63/365,388, filed on May 26, 2022.

(51) Int. Cl. G06Q 20/40; G06Q 20/10

(52) U.S. Cl. CPC G06Q 20/4014; G06Q 20/102

(57) ABSTRACT

An interchange computer system includes a billing computer relationship that has a plurality of reference billing computer identifiers and a plurality of reference sensory representations, wherein each reference sensory representation is associated with a respective reference billing computer identifier. A billing identifier receiver receives, from a payment portal computer system, a billing identifier representing a user. A billing identifier transmission module transmits the billing identifier to a plurality of remote billing computer systems at the respective reference billing computer identifiers. A response receiving module receives a positive response from one or more of the billing computer systems. A sensory representation selection module determines select sensory representations for presentation and confirmation by a user at a user computer system connected to the payment portal computer system.

### CROSS-REFERENCE TO RELATED APPLICATIONS

This is application claims priority from U.S. Provisional Patent Application No. 63/365,388, filed on May 26, 2022, all of which is incorporated herein by reference in its entirety.

### BACKGROUND OF THE INVENTION

1). Field of the Invention

This invention relates to a method and system for identifying and charging a user.

2). Discussion of Related Art

A network that is used for online purchases usually includes a user computer system, a payment portal computer system, and a billing computer system. A user may use the user computer system to select goods or services on the payment portal computer system following which they are presented with an interface for making a payment. The interface may have a payment service selection option for the purposes of communicating with various billing computer systems. After the user has made a selection of which payment service they wish to use, they may be presented with a list of possible payment methods. The user will then select the method he or she prefers to link them as a payer at a point in time to the underlying issuer. This link could be performed by the use of a static unique number (e.g., card payment) or unique account name (incl. associated email address) or a unique image scanned with a computer device's camera (quick response code). This first factor of authentication is often combined with a second factor of authentication typically being the additional provision of a factor of knowledge (password), inherence (thumbprint scan) or possession (SMS OTP). The payment portal computer system can then communicate with the relevant billing computer system and place a charge after linking and authenticating the payer at a point in time to the relevant billing computer system.

Repeated purchases rely on a user experience that contains a relatively high degree of friction for non card payments. A user may have to identify their own payment method or in the case of an real time/open banking or e-wallet payment method, they may be required to identify their issuer out of hundreds to initiate the payment or instead rely on a less secure linking medium to the issuer (e.g., a card payment). The friction that is created for the user may lead to a loss of the user by a merchant making use of the payment portal computer system. It can also lead to certain payment methods having an advantage over others due to friction involved. Retention of users during the payment process can lead to increased revenues to the merchant, especially when choosing different and cheaper payment methods. Reliance on methods that link the payer to their issuer account via a less secure method (e.g., a static card payment) can result in a higher number of losses for a merchant in the form of chargebacks attached to payment disputes or unauthorised transactions.

### SUMMARY OF THE INVENTION

The invention provides a method of charging a user executed with a payment portal computer system, including receiving, with an interface of the payment portal computer system, a billing identifier representing a user, transmitting, with a processor of the payment portal computer system, the billing identifier to an interchange computer system, receiving, with the processor of the payment portal computer system, from the interchange computer system, in response to the transmitting, with a processor of the payment portal computer system, the billing identifier to the interchange computer system, a select sensory representation, receiving, with an interface of the payment portal computer system, a confirmation of the select sensory representation from the user, and transmitting, with the processor of the payment portal computer system, the confirmation to the interchange computer system.

The method may further include that the processor of the payment portal computer system receives a plurality of select sensory representations, wherein the interface of the payment portal computer system receives a confirmation of one of the select sensory representation from the user, and wherein the processor of the payment portal computer system transmits the confirmation of the one select sensory representation to the interchange computer system.

The method may further include that the sensory representations are names that can be read by the user.

The method may further include that the names are presented as a list using an iFrame residing on the interchange computer system.

The method may further include that the sensory representation is a name that can be read by the user.

The method may further include that the sensory representation includes “bank”.

The method may further include that the sensory representation includes “trust”.

The method may further include that the sensory representation includes at least one of a visual representation, an audible representation, and a tactile representation.

The invention also provides a payment portal computer system, including a processor, a storage device connected to the processor, and a set of instructions on the storage device. The set of instructions may include an interface adapted to receive a billing identifier representing a user, a billing identifier transmission module, executable by the processor, to transmit the billing identifier to an interchange computer system, a sensory representation reception module, executable by the processor, to receive, from the interchange computer system, in response to the transmitting, with a processor of the payment portal computer system, the billing identifier to the interchange computer system, a select sensory representation, a confirmation reception module, executable by the processor, to receive, with an interface of the payment portal computer system, a confirmation of the select sensory representation from the user, and a confirmation transmission module, executable by the processor, to transmit the confirmation to the interchange computer system.

The method may further include that the processor of the payment portal computer system receives a plurality of select sensory representations, wherein the interface of the payment portal computer system receives a confirmation of one of the select sensory representation from the user, and wherein the processor of the payment portal computer system transmits the confirmation of the one select sensory representation to the interchange computer system.

The method may further include that the sensory representations are names that can be read by the user.

The method may further include that the names are presented as a list using an iFrame residing on the interchange computer system.

The method may further include that the sensory representation is a name that can be read by the user.

The method may further include that the sensory representation includes “bank”.

The method may further include that the sensory representation includes “trust”.

The method may further include that the sensory representation includes at least one of a visual representation, an audible representation, and a tactile representation.

The invention further provides a method of charging a user, executed with an interchange computer system, including storing, with a processor of the interchange computer system, a billing computer relationship that includes a plurality of reference billing computer identifiers and a plurality of reference sensory representations, wherein each reference sensory representation is associated with a respective reference billing computer identifier, receiving, with a processor of an interchange computer system, from a payment portal computer system, a billing identifier representing a user, storing, with the processor of the interchange computer system, the billing identifier in a storage device of the interchange computer system, transmitting, with the processor of the interchange computer system, the billing identifier to a plurality of remote billing computer systems at the respective reference billing computer identifiers, receiving, with the processor of the interchange computer system, in response to the transmitting, with the processor of the interchange computer system, of the billing identifier to the plurality of remote billing computer systems, a positive response from at least one of the billing computer systems, wherein the positive response includes the billing identifier and an identifier of the billing computer system, associating, with the processor of the interchange computer system, the positive response with the billing identifier stored in the storage device, determining, with the processor of the interchange computer system, from the billing computer relationship, a select sensory representation from the reference sensory representations of the billing computer associated with the identifier of the billing computer system received with the processor of the interchange computer system, transmitting, with the processor of the interchange computer system, the select sensory representation to the payment portal computer system; receiving, with the processor of the interchange computer system, from the payment portal computer system, a confirmation of the select sensory representation, and transmitting, with the processor of the interchange computer system, a charge request to the billing computer identifier associated with the select sensory representation in the billing computer relationship.

The method may further include that the processor of the interchange computer system receives a positive response from each of at least two of the billing computer systems, wherein the each positive response includes the billing identifier and an identifier of the respective billing computer system, wherein the processor of the interchange computer system associates the positive responses with the billing identifier stored in the storage device, wherein the processor of the interchange computer system determines, from the billing computer relationship, a select sensory representation from the reference sensory representations of the billing computer associated with the identifiers of the billing computer systems received with the processor of the interchange computer system, wherein the processor of the interchange computer system transmits the select sensory representations to the payment portal computer system, wherein the processor of the interchange computer system receives a confirmation of one of the select sensory representations, and wherein the processor of the interchange computer system transmits a charge request to the billing computer identifier associated with the of one of the select sensory representation in the billing computer relationship.

The method may further include that the sensory representations are names that can be read by the user.

The method may further include that the names are presented as a list using an iFrame residing on the interchange computer system.

The method may further include that the sensory representation is a name that can be read by the user.

The method may further include that the interchange computer system receives at least one negative response from one of the billing computer systems.

The method may further include that the sensory representation includes “bank”.

The method may further include that the sensory representation includes “trust”.

The method may further include that the sensory representation includes at least one of a visual representation, an audible representation, and a tactile representation.

The invention also provides an interchange computer system, including a processor, a storage device connected to the processor, and a set of instructions on the storage device. The set of instructions may include a billing computer relationship that includes a plurality of reference billing computer identifiers and a plurality of reference sensory representations, wherein each reference sensory representation is associated with a respective reference billing computer identifier, a billing identifier receiver, executable by the processor, to receive, from a payment portal computer system, a billing identifier representing a user, a billing identifier storing module, executable by the processor, to store the billing identifier in the storage device, a billing identifier transmission module, executable by the processor, to transmit the billing identifier to a plurality of remote billing computer systems at the respective reference billing computer identifiers, a response receiving module, executable by the processor, to receive in response to the transmitting, with the billing identifier transmission module, of the billing identifier to the plurality of remote billing computer systems, a positive response from at least one of the billing computer systems, wherein the positive response includes the billing identifier and an identifier of the billing computer system, a response association module, executable by the processor, to associate the positive response with the billing identifier stored in the storage device, a sensory representation selection module, executable by the processor, to determine, from the billing computer relationship, a select sensory representation from the reference sensory representations of the billing computer associated with the identifier of the billing computer system received with the processor of the interchange computer system, a sensory representation transmission module, executable by the processor, to transmit, the select sensory representation to the payment portal computer system, a confirmation reception module, executable by the processor, to receive, from the payment portal computer system, a confirmation of the select sensory representation, and a charge request transmission module, executable by the processor, to transmit a charge request to the billing computer identifier associated with the select sensory representation in the billing computer relationship.

The system may further include that the processor of the interchange computer system receives a positive response from each of at least two of the billing computer systems, wherein the each positive response includes the billing identifier and an identifier of the respective billing computer system, wherein the processor of the interchange computer system associates the positive responses with the billing identifier stored in the storage device, wherein the processor of the interchange computer system determines, from the billing computer relationship, a select sensory representation from the reference sensory representations of the billing computer associated with the identifiers of the billing computer systems received with the processor of the interchange computer system, wherein the processor of the interchange computer system transmits the select sensory representations to the payment portal computer system, wherein the processor of the interchange computer system receives a confirmation of one of the select sensory representations, and wherein the processor of the interchange computer system transmits a charge request to the billing computer identifier associated with the of one of the select sensory representation in the billing computer relationship.

The system may further include that the sensory representations are names that can be read by the user.

The system may further include that the names are presented as a list using an iFrame residing on the interchange computer system.

The system may further include that the sensory representation is a name that can be read by the user.

The system may further include that the interchange computer system receives at least one negative response from one of the billing computer systems.

The system may further include that the sensory representation includes “bank”.

The system may further include that the sensory representation includes “trust”.

The system may further include that the sensory representation includes at least one of a visual representation, an audible representation, and a tactile representation.

The invention further provides a method of charging a user executed with a billing computer system, including storing, with a processor of the billing computer system, in a data store of the billing computer system, a plurality of reference identifiers wherein each reference identifier represents a respective customer, receiving, with the processor of the billing computer system, from an interchange computer system, a billing identifier representing a user, and determining, with the processor of the billing computer system, whether the billing identifier matches any one of the reference identifiers. If the billing identifier matches one of the reference identifiers then, transmitting, with the processor of the billing computer system, a positive response to the interchange computer system, wherein the positive response includes the billing identifier and an identifier of the billing computer system, wherein the positive response is not transmitted if the billing identifier does not match one of the reference identifiers, receiving, with the processor of the billing computer system, from the interchange computer system, in response to transmitting, with the processor of the billing computer system, the positive response to the interchange computer system, a charge request, and charging, with the processor of the billing computer system, an account associated with the reference identifier matching the billing identifier in the data store.

The method may further include that the processor of the billing computer system, if the positive response is not transmitted if the billing identifier does not match one of the reference identifiers, transmits a negative response to the interchange computer system.

The method may further include that the sensory representation includes “bank”.

The method may further include that the sensory representation includes “trust”.

The method may further include that the sensory representation includes at least one of a visual representation, an audible representation, and a tactile representation.

The invention also provides a billing computer system, including a processor, a storage device connected to the processor, and a set of instructions on the storage device. The set of instructions may include a data store, a plurality of reference identifiers in the data store, wherein each reference identifier represents a respective customer, a billing identifier reception module, executable by the processor, to receive, from an interchange computer system, a billing identifier representing a user, a matching module, executable by the processor, to determine whether the billing identifier matches any one of the reference identifiers, a response transmission module, executable by the processor, if the billing identifier matches one of the reference identifiers then, to transmit a positive response to the interchange computer system, wherein the positive response includes the billing identifier and an identifier of the billing computer system, wherein the positive response is not transmitted if the billing identifier does not match one of the reference identifiers, a plurality of accounts, each account being associated with a respective one of the reference identifiers, a charge request reception module, executable by the processor, to receive, from the interchange computer system, in response to transmitting, with the response transmission module, the positive response to the interchange computer system, a charge request, and a charging module, executable by the processor, to charge an account associated with the reference identifier matching the billing identifier in the data store.

The system may further include that the response transmission module, if the positive response is not transmitted if the billing identifier does not match one of the reference identifiers, transmits a negative response to the interchange computer system.

The method may further include that the sensory representation includes “bank”.

The method may further include that the sensory representation includes “trust”.

The method may further include that the sensory representation includes at least one of a visual representation, an audible representation, and a tactile representation.

### BRIEF DESCRIPTION OF THE DRAWINGS

The invention is further described by way of example with reference to the accompanying drawings, wherein:

FIG. 1 is a block diagram of a network according to the invention that includes an interchange computer system that is used between a payment portal computer system and a plurality of billing computer systems to determine a select billing computer system which a user at a user computer system wishes to use for placing a charge;

FIG. 2 is a flow chart illustrating the functioning of the network;

FIG. 3 is a physical representation of an interface that is presented to the user to confirm a select institution for making a payment; and

FIG. 4 is a block diagram of a machine in the form of a computer that can find application in the present invention system, in accordance with one embodiment of the invention.

### DETAILED DESCRIPTION OF THE INVENTION

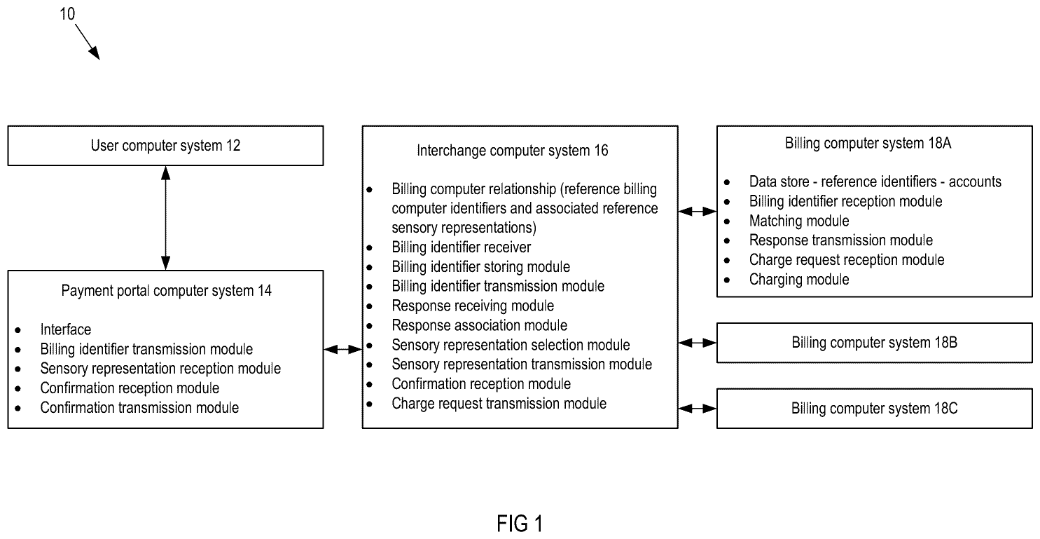

FIG. 1 illustrates a computer network 10 according to an embodiment of the invention, including a user computer system 12, a payment portal computer system 14, an interchange computer system 16, and a plurality of billing computer systems 18A, 18B and 18C.

The user computer system 12 may, for example, be a hand-held device or a desktop computer. The user computer system 12 is connected over the Internet to the payment portal computer system 14. The payment portal computer system 14 may, for example, be a merchant computer system. A consumer at the user computer system 12 may, for example, make a purchase on the payment portal computer system 14. Alternatively, the user computer system 12 may be a checkout terminal at a physical location of a merchant.

The interchange computer system 16 is connected to the payment portal computer system 14 over the Internet. The payment portal computer system 14 and the interchange computer system 16 have application programmable interfaces (API's) that communicate with each other. The interchange computer system 16 may communicate with the user computer system 12 using an iFrame that resides on the interchange computer system 16 and that is presented within a website of the payment portal computer system 14.

The interchange computer system 16 is connected to the billing computer systems 18A, 18B and 18C. Each one of the billing computer systems 18A, 18B or 18C has its own API that is programmed to communicate with an API on the interchange computer system 16. The billing computer systems 18A, 18B and 18C may, for example, be billing computer systems of banks, banking trusts or organizations that hold accounts of consumers that are identified by reference identifiers such as account numbers, credit card numbers, phone numbers, email addresses, etc.

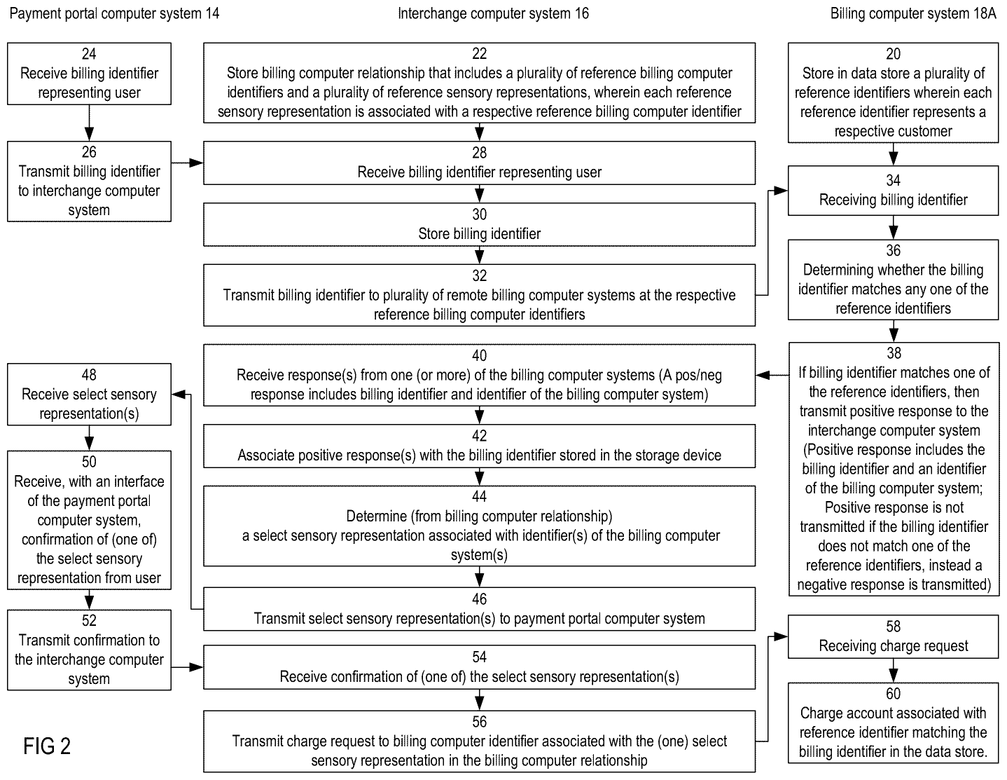

FIG. 2 illustrates the functioning of the network 10 of FIG. 1. At 20, the billing computer system 18A stores a plurality of reference identifiers in a data store. Each reference identifier represents a respective customer. Reference identifiers are of a type that can normally be remembered by a customer, such as their phone number or their email address. Each reference identifier is also associated with an account on the billing computer system 18A of the respective customer. The account may be identified on the billing computer system 18A with an account number, an account name or other identifier that may not easily be remembered by a customer. Alternatively, each account can be identified by the reference identifier of the account without having an account number or an account name.

At 22, the interchange computer system 16 stores a billing computer relationship that includes a plurality of reference billing computer identifiers and a plurality of reference sensory representations. Each reference sensory representation is associated with a respective billing computer identifier. Each reference billing computer identifier identifies, on the interchange computer system 16, one of the billing computer systems 18A, 18B or 18C in FIG. 1. The reference billing computer identifiers serve as addresses that the interchange computer system 16 uses to communicate data to a respective one of the billing computer systems 18A, 18B or 18C.

For purposes of this discussion, a sensory representation is a name of an organization of a respective one of the billing computer systems 18A, 18B or 18C. A name may, for example, be a name of a bank, a name of a bank trust, a name of a payment processing institution, etc. In the case of a name, the name can be seen by a user and therefore represents a visual sensory representation. Another visual sensory representation may, for example, be a logo. Other sensory representations may be audible sensory representations such as the sound of a name of a payment institution when it is spoken and thus heard by a user or tactile sensory representations. In the given example, each one of the billing computer systems 18A, 18B and 18C has a respective reference billing computer identifier and a respective name associated with the respective reference billing computer identifier.

At 24, the payment portal computer system 14 receives a billing identifier representing a user. The billing identifier may, for example, be an email address or a phone number of the user. At 26, the payment portal computer system 14 transmits the billing identifier to the interchange computer system 16. At 28, the interchange computer system 16 receives the billing identifier representing the user from the payment portal computer system 14. At 30, the interchange computer system 16 stores the billing identifier in a data store of the interchange computer system 16.

At 32, the interchange computer system 16 transmits the billing identifier to the plurality of remote billing computer systems 18A, 18B and 18C in FIG. 1 at the respective reference billing computer identifiers. As noted above, the billing computer identifiers were previously stored at step 22.

At 34, the billing computer system 18A receives the billing identifier from the interchange computer system 16. At 36, the billing computer system 18A determines whether the billing identifier matches any one of the reference identifiers that were previously stored at step 20. At 38, if the billing identifier matches one of the reference identifiers, then the billing computer system 18A transmits a positive response to the interchange computer system 16. The positive response includes the billing identifier and an identifier of the billing computer system 18A. A positive response is not transmitted if the billing identifier does not match one of the reference identifiers. Instead, a negative response is transmitted, or no response is transmitted.

Although steps 20, 24, 36 and 38 are shown for only the billing computer system 18A, it should be understood that the same steps are carried out for each one of the billing computer systems 18A, 18B and 18C. Each one of the billing computer systems 18A, 18B and 18C, at 20, stores a plurality of reference identifiers. Some of the reference identifiers may overlap while other reference identifiers may not overlap between the billing computer systems 18A, 18B and 18C.

At 40, the interchange computer system 16 receives at least one positive response from one of the billing computer systems 18A, 18B or 18C. The positive response includes the billing identifier and the identifier of the billing computer system 18A, 18B or 18C from which the response is received. If more than one response is received, then each response includes the billing identifier and a respective identifier of a respective billing computer system 18A, 18B or 18C. Any negative responses will also include the billing identifier and the identifier of the respective billing computer system 18A, 18B or 18C.

At 42, the interchange computer system 16 associates any positive responses with the billing identifier stored in the storage device. The billing identifier is thus used for matching outgoing queries at 32 and responsive incoming queries at 40. The interchange computer system 16 can manage multiple outgoing queries at 32 and receive multiple responses at 40 and keeps track of the responses by cross matching sent and received billing identifiers.

At 44, the interchange computer system 16 determines a select sensory representation associated with the respective billing computer system 18A, 18B or 18C from which the response is received. The select sensory representation is determined from the billing computer relationship stored at 22. If more than one positive response is received, then the interchange computer system 16 determines a plurality of select sensory representations associated with the respective identifiers of the respective billing computer systems 18A, 18B and 18C from which the response is received. At 46, the interchange computer system 16 transmits the select sensory representation or representations to the payment portal computer system 14. The select sensory representation or representations that are transmitted only include sensory representations for which positive responses are received from their respective billing computer systems 18A, 18B and 18C.

At 48, the payment portal computer system 14 receives the select sensory representation or representations from the interchange computer system 16. The user is presented with an interface on the user computer system 12 through which the user can make the selection. At 50, the payment portal computer system 14 receives a confirmation of one of the select sensory representations from the user. At 52, the payment portal computer system 14 transmits the confirmation to the interchange computer system 16.

At 54, the interchange computer system 16 receives the confirmation of the one select sensory representation. The interchange computer system 16 can then determine one of the billing computer systems 18A, 18B or 18C which the user wishes to use for purposes of billing for the purchase. If only one select sensory representation is transmitted at 46, then the confirmation serves as a confirmation by the user that they wish for the charge to appear on the billing computer system 18A, 18B or 18C referenced by the one sensory representation. If multiple sensory representations are transmitted at 46, then the confirmation serves as a confirmation from the user of a select one of the billing computer systems 18A, 18B or 18C where the user wishes the charge to appear.

At 56, the interchange computer system 16 transmits a charge request to the billing computer identifier associated with the one select sensory representation in the billing computer relationship. The charge request includes an amount that has to be charged. The interchange computer system 16 may receive the charge request from the payment portal computer system 14 at step 28 or at step 54. In the present example, the charge request is transmitted only to the billing computer system 18A. Because the charge request is only transmitted to one billing computer system 18A, the charge request is not also transmitted to the billing computer systems 18B and 18C. At 58, the billing computer system 18A receives the charge request. At 60, the billing computer system 18A charges an account associated with the reference identifier matching the billing identifier in the data store.

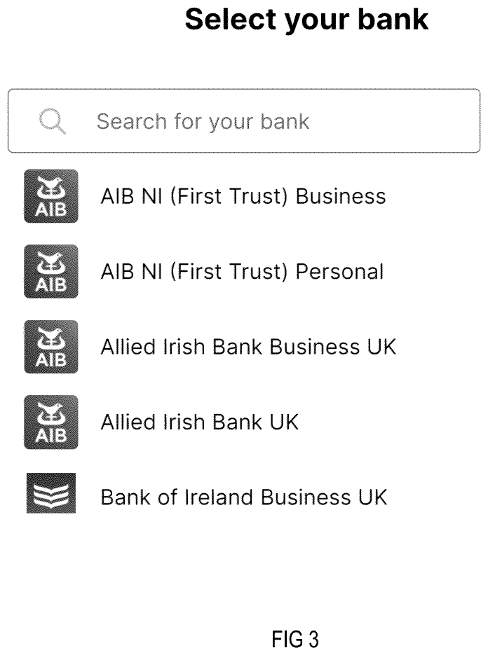

FIG. 3 illustrates an interface that is presented to the user at the user computer system 12 in FIG. 1 after the payment portal computer system 14 receives the sensory representations at 48 in FIG. 2. In the present example, the sensory representations are names of institutions to which the respective billing computer systems 18A, 18B and 18C belong and many of the names include “bank” or “trust”. The names are only the names of the institutions from which positive responses are received from respective billing computer systems 18A, 18B or 18C. The user can then make a selection of one of the names, and that selection serves as the confirmation that is received by the payment portal computer system 14 at 50 in FIG. 2.

The processes and steps carried out in FIG. 2 are carried out by various modules as represented in FIG. 1. The payment portal computer system 14 includes:
Interface
Billing identifier transmission module
Sensory representation reception module
Confirmation reception module
Confirmation transmission module

The interchange computer system 16 includes:
Billing computer relationship (reference billing computer identifiers and associated reference sensory representations)
Billing identifier receiver
Billing identifier storing module
Billing identifier transmission module
Response receiving module
Response association module
Sensory representation selection module
Sensory representation transmission module
Confirmation reception module
Charge request transmission module

The billing computer system includes:
Data store—reference identifiers—accounts
Billing identifier reception module
Matching module
Response transmission module
Charge request reception module
Charging module

The functioning of the various components and modules should be evident from the foregoing description of FIG. 2.

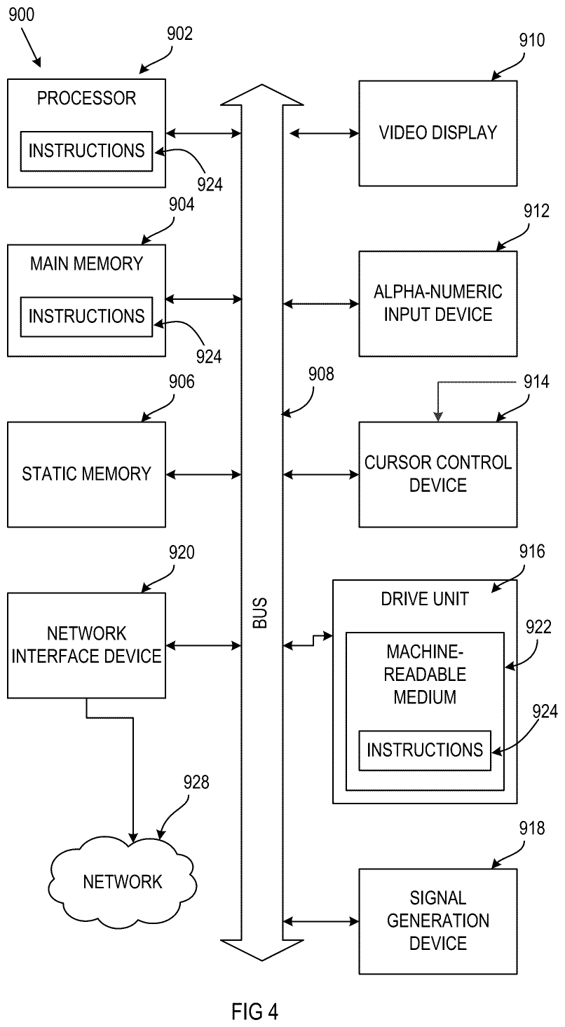

FIG. 4 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 902 (e.g., a central processing unit (CPU), a graphics processing unit (GPU) or both), a main memory 904 (e.g., read only memory (ROM), flash memory, dynamic random access memory (DRAM) such as synchronous DRAM (SDRAM) or Rambus DRAM (RDRAM), etc.), and a static memory 906 (e.g., flash memory, static random access memory (SRAM), etc.), which communicate with each other via a bus 908.

The computer system 900 may further include a video display 910 (e.g., a liquid crystal display (LCD) or a cathode ray tube (CRT)). The computer system 900 also includes an alpha-numeric input device 912 (e.g., a keyboard), a cursor control device 914 (e.g., a mouse), a disk drive unit 916, a signal generation device 918 (e.g., a speaker), and a network interface device 920.

The disk drive unit 916 includes a machine-readable medium 922 on which is stored one or more sets of instructions 924 (e.g., software) embodying any one or more of the methodologies or functions described herein. The software may also reside, completely or at least partially, within the main memory 904 and/or within the processor 902 during execution thereof by the computer system 900, the main memory 904 and the processor 902 also constituting machine-readable media.

The software may further be transmitted or received over a network 928 via the network interface device 920.

While the machine-readable medium 924 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of charging a user, executed with a payment portal computer system, comprising:
receiving, with an interface of the payment portal computer system, a billing identifier representing a user;
transmitting, with a processor of the payment portal computer system, the billing identifier to an interchange computer system;
receiving, with the processor of the payment portal computer system, from the interchange computer system, in response to the transmitting, with a processor of the payment portal computer system, the billing identifier to the interchange computer system, a select sensory representation;
receiving, with an interface of the payment portal computer system, a confirmation of the select sensory representation from the user; and
transmitting, with the processor of the payment portal computer system, the confirmation to the interchange computer system.

2. The method of claim 1, wherein the processor of the payment portal computer system receives a plurality of select sensory representations, wherein the interface of the payment portal computer system receives a confirmation of one of the select sensory representation from the user, and wherein the processor of the payment portal computer system transmits the confirmation of the one select sensory representation to the interchange computer system.

3. The method of claim 2, wherein the sensory representations are names that can be read by the user.

4. The method of claim 3, wherein the names are presented as a list using an iFrame residing on the interchange computer system.

5. The method of claim 1, wherein the sensory representation is a name that can be read by the user.

6. The method of claim 1, wherein the sensory representation includes “bank”.

7. The method of claim 1, wherein the sensory representation includes “trust”.

8. The method of claim 1, wherein the sensory representation includes at least one of a visual representation, an audible representation, and a tactile representation.

9. A payment portal computer system, comprising:
a processor;
a storage device connected to the processor;
a set of instructions on the storage device, including:
an interface adapted to receive a billing identifier representing a user;
a billing identifier transmission module, executable by the processor, to transmit the billing identifier to an interchange computer system;
a sensory representation reception module, executable by the processor, to receive, from the interchange computer system, in response to the transmitting, with a processor of the payment portal computer system, the billing identifier to the interchange computer system, a select sensory representation;
a confirmation reception module, executable by the processor, to receive, with an interface of the payment portal computer system, a confirmation of the select sensory representation from the user; and
a confirmation transmission module, executable by the processor, to transmit, the confirmation to the interchange computer system.

10. The method of claim 9, wherein the processor of the payment portal computer system receives a plurality of select sensory representations, wherein the interface of the payment portal computer system receives a confirmation of one of the select sensory representation from the user, and wherein the processor of the payment portal computer system transmits the confirmation of the one select sensory representation to the interchange computer system.

11. The method of claim 10, wherein the sensory representations are names that can be read by the user.

12. The method of claim 11, wherein the names are presented as a list using an iFrame residing on the interchange computer system.

13. The method of claim 9, wherein the sensory representation is a name that can be read by the user.

14. The method of claim 9, wherein the sensory representation includes “bank”.

15. The method of claim 9, wherein the sensory representation includes “trust”.

16. The method of claim 9, wherein the sensory representation includes at least one of a visual representation, an audible representation, and a tactile representation.

17. A method of charging a user executed with an interchange computer system, comprising:
storing, with a processor of the interchange computer system, a billing computer relationship that includes a plurality of reference billing computer identifiers and a plurality of reference sensory representations, wherein each reference sensory representation is associated with a respective reference billing computer identifier;
receiving, with a processor of an interchange computer system, from a payment portal computer system, a billing identifier representing a user;
storing, with the processor of the interchange computer system, the billing identifier in a storage device of the interchange computer system;
transmitting, with the processor of the interchange computer system, the billing identifier to a plurality of remote billing computer systems at the respective reference billing computer identifiers;
receiving, with the processor of the interchange computer system, in response to the transmitting, with the processor of the interchange computer system, of the billing identifier to the plurality of remote billing computer systems, a positive response from at least one of the billing computer systems, wherein the positive response includes the billing identifier and an identifier of the billing computer system;
associating, with the processor of the interchange computer system, the positive response with the billing identifier stored in the storage device;
determining, with the processor of the interchange computer system, from the billing computer relationship, a select sensory representation from the reference sensory representations of the billing computer associated with the identifier of the billing computer system received with the processor of the interchange computer system;
transmitting, with the processor of the interchange computer system, the select sensory representation to the payment portal computer system;
receiving, with the processor of the interchange computer system, from the payment portal computer system, a confirmation of the select sensory representation; and
transmitting, with the processor of the interchange computer system, a charge request to the billing computer identifier associated with the select sensory representation in the billing computer relationship.

18. The method of claim 17, wherein the processor of the interchange computer system receives a positive response from each of at least two of the billing computer systems,
wherein the each positive response includes the billing identifier and an identifier of the respective billing computer system, wherein the processor of the interchange computer system associates the positive responses with the billing identifier stored in the storage device,
wherein the processor of the interchange computer system determines, from the billing computer relationship, a select sensory representation from the reference sensory representations of the billing computer associated with the identifiers of the billing computer systems received with the processor of the interchange computer system,
wherein the processor of the interchange computer system transmits the select sensory representations to the payment portal computer system,
wherein the processor of the interchange computer system receives a confirmation of one of the select sensory representations, and
wherein the processor of the interchange computer system transmits a charge request to the billing computer identifier associated with the of one of the select sensory representation in the billing computer relationship.

19. The method of claim 18, wherein the sensory representations are names that can be read by the user.

20. The method of claim 19, wherein the names are presented as a list using an iFrame residing on the interchange computer system.

21. The method of claim 17, wherein the sensory representation is a name that can be read by the user.

22. The method of claim 17, wherein the interchange computer system, receives at least one negative response from one of the billing computer systems.

23. The method of claim 17, wherein the sensory representation includes “bank”.

24. The method of claim 17, wherein the sensory representation includes “trust”.

25. The method of claim 17, wherein the sensory representation includes at least one of a visual representation, an audible representation, and a tactile representation.

26. An interchange computer system, comprising:
a processor;
a storage device connected to the processor;
a set of instructions on the storage device, including:
a billing computer relationship that includes a plurality of reference billing computer identifiers and a plurality of reference sensory representations, wherein each reference sensory representation is associated with a respective reference billing computer identifier;
a billing identifier receiver, executable by the processor, to receive, from a payment portal computer system, a billing identifier representing a user;
a billing identifier storing module, executable by the processor, to store the billing identifier in the storage device;
a billing identifier transmission module, executable by the processor, to transmit the billing identifier to a plurality of remote billing computer systems at the respective reference billing computer identifiers;
a response receiving module, executable by the processor, to receive in response to the transmitting, with the billing identifier transmission module, of the billing identifier to the plurality of remote billing computer systems, a positive response from at least one of the billing computer systems, wherein the positive response includes the billing identifier and an identifier of the billing computer system;
a response association module, executable by the processor, to associate the positive response with the billing identifier stored in the storage device;
a sensory representation selection module, executable by the processor, to determine, from the billing computer relationship, a select sensory representation from the reference sensory representations of the billing computer associated with the identifier of the billing computer system received with the processor of the interchange computer system;
a sensory representation transmission module, executable by the processor, to transmit, the select sensory representation to the payment portal computer system;
a confirmation reception module, executable by the processor, to receive, from the payment portal computer system, a confirmation of the select sensory representation; and
a charge request transmission module, executable by the processor, to transmit a charge request to the billing computer identifier associated with the select sensory representation in the billing computer relationship.

27. The system of claim 26, wherein the processor of the interchange computer system receives a positive response from each of at least two of the billing computer systems,
wherein the each positive response includes the billing identifier and an identifier of the respective billing computer system,
wherein the processor of the interchange computer system associates the positive responses with the billing identifier stored in the storage device,
wherein the processor of the interchange computer system determines, from the billing computer relationship, a select sensory representation from the reference sensory representations of the billing computer associated with the identifiers of the billing computer systems received with the processor of the interchange computer system,
wherein the processor of the interchange computer system transmits the select sensory representations to the payment portal computer system,
wherein the processor of the interchange computer system receives a confirmation of one of the select sensory representations, and
wherein the processor of the interchange computer system transmits a charge request to the billing computer identifier associated with the of one of the select sensory representations in the billing computer relationship.

28. The system of claim 27, wherein the sensory representations are names that can be read by the user.

29. The system of claim 28, wherein the names are presented as a list using an iFrame residing on the interchange computer system.

30. The system of claim 26, wherein the sensory representation is a name that can be read by the user.

31. The system of claim 26, wherein the interchange computer system, receives at least one negative response from one of the billing computer systems.

32. The system of claim 26, wherein the sensory representation includes “bank”.

33. The system of claim 26, wherein the sensory representation includes “trust”.

34. The system of claim 26, wherein the sensory representation includes at least one of a visual representation, an audible representation, and a tactile representation.

35. A method of charging a user executed with a billing computer system, comprising:
storing, with a processor of the billing computer system, in a data store of the billing computer system, a plurality of reference identifiers wherein each reference identifier represents a respective customer;
receiving, with the processor of the billing computer system, from an interchange computer system, a billing identifier representing a user;
determining, with the processor of the billing computer system, whether the billing identifier matches any one of the reference identifiers;
if the billing identifier matches one of the reference identifiers, then transmitting, with the processor of the billing computer system, a positive response to the interchange computer system, wherein the positive response includes the billing identifier and an identifier of the billing computer system, wherein the positive response is not transmitted if the billing identifier does not match one of the reference identifiers;
receiving, with the processor of the billing computer system, from the interchange computer system, in response to transmitting, with the processor of the billing computer system, the positive response to the interchange computer system, a charge request; and
charging, with the processor of the billing computer system, an account associated with the reference identifier matching the billing identifier in the data store.

36. The method of claim 35, wherein the processor of the billing computer system, if the positive response is not transmitted if the billing identifier does not match one of the reference identifiers, transmits a negative response to the interchange computer system.

37. The method of claim 35, wherein the sensory representation includes “bank”.

38. The method of claim 35, wherein the sensory representation includes “trust”.

39. The method of claim 35, wherein the sensory representation includes at least one of a visual representation, an audible representation, and a tactile representation.

40. A billing computer system, comprising:
a processor;
a storage device connected to the processor;
a set of instructions on the storage device, including:
a data store;
a plurality of reference identifiers in the data store, wherein each reference identifier represents a respective customer;
a billing identifier reception module, executable by the processor, to receive, from an interchange computer system, a billing identifier representing a user;
a matching module, executable by the processor, to determine whether the billing identifier matches any one of the reference identifiers;
a response transmission module, executable by the processor, if the billing identifier matches one of the reference identifiers, then to transmit a positive response to the interchange computer system, wherein the positive response includes the billing identifier and an identifier of the billing computer system, wherein the positive response is not transmitted if the billing identifier does not match one of the reference identifiers;
a plurality of accounts, each account being associated with a respective one of the reference identifiers;
a charge request reception module, executable by the processor, to receive, from the interchange computer system, in response to transmitting, with the response transmission module, the positive response to the interchange computer system, a charge request; and
a charging module, executable by the processor, to charge an account associated with the reference identifier matching the billing identifier in the data store.

41. The system of claim 40, wherein the response transmission module, if the positive response is not transmitted if the billing identifier does not match one of the reference identifiers, transmits a negative response to the interchange computer system.

42. The method of claim 40, wherein the sensory representation includes “bank”.

43. The method of claim 40, wherein the sensory representation includes “trust”.

44. The method of claim 40, wherein the sensory representation includes at least one of a visual representation, an audible representation, and a tactile representation.
